(19) United States
(12) Patent Application Publication
(10) Pub. No.: US 2026/0255247 A1
(43) Pub. Date: Aug. 27, 2026

(54) Methods And Apparatus For Early Mobility And Reporting In Mobile Communications

(71) Applicant: MediaTek Inc., Hsinchu City (TW)

(72) Inventors: Jen-Chien Liu, Hsinchu City (TW); Keng-Ming Huang, Hsinchu City (TW); Tsung-Ming Lee, Hsinchu City (TW); Chun-Fan Tsai, Hsinchu City (TW); Tsung-Liang Lu, Hsinchu City (TW)

(73) Assignee: MediaTek Inc., Hsinchu City (TW)

(21) Appl. No.: 19/530,396

(22) Filed: Feb. 5, 2026

Related U.S. Application Data
(60) Provisional application No. 63/762,679, filed on Feb. 25, 2025.

(51) Int. Cl. H04W 36/30; H04W 24/08

(52) U.S. Cl. CPC H04W 36/304; H04W 24/08

(57) ABSTRACT

Various solutions for early mobility and reporting between a user equipment (UE) and a serving cell are described. The UE may perform a first measurement on a neighbor cell and determine whether a condition is met based on the first measurement. The UE may trigger a mobility procedure during a connection establishment procedure or a connection resume procedure in an event that the condition is met. The serving cell may receive a radio resource control (RRC) complete message and determine whether the mobility procedure is indicated in the RRC complete message. The serving cell may perform a reporting procedure for acquiring measurement results in an event that the mobility procedure is indicated in the RRC complete message.

### CROSS REFERENCE TO RELATED PATENT APPLICATIONS

The present disclosure is part of a non-provisional application claiming the priority benefits of U.S. Patent Application No. 63/762,679, filed on 25 February 2025, the content of which herein being incorporated by reference in its entirety.

### TECHNICAL FIELD

The present disclosure is generally related to mobile communications and, more particularly, to early mobility and reporting procedures in the cell edge with respect to apparatus in mobile communications.

### BACKGROUND

Unless otherwise indicated herein, approaches described in this section are not prior art to the claims listed below and are not admitted as prior art by inclusion in this section.

In mobile communications, a mobility (e.g., handover) decision determines whether user equipment (UE) should handover or not. The base station determines the mobility decision based on measurement reports from the UE. Third generation partnership project (3GPP) specifications have proposed a predefined set of measurement report mechanisms to be performed by the UE. The base station may configure the UE to report serving cell and neighbor cell signal quality and trigger a handover with a single measurement. There are multiple measurement items (RSRP, RSRQ, SINR) and multiple ways (e.g., periodic or event-triggered) to measure the signal quality of the serving cell and neighbor cells. The UE moving towards the cell edge or moving back into good coverage of the serving cell affects whether to trigger a mobility procedure.

Accordingly, designing appropriate mobility and reporting procedures for a new generation communication system has become a critical issue in wireless communication systems, and there is an urgent need to provide such procedures to ensure efficient and reliable operation.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to early mobility and reporting procedures in the cell edge with respect to apparatus in mobile communications.

In one aspect, a method may involve an apparatus performing a first measurement. The method may also involve the apparatus evaluating whether a condition is met based on the first measurement. The method may further involve the apparatus triggering a mobility procedure during a connection establishment procedure or a connection resume procedure in an event that the condition is met.

In one aspect, an apparatus may comprise a transceiver which, during operation, wirelessly communicates with a network node. The apparatus may also comprise a processor communicatively coupled to the transceiver. The processor, during operation, may perform operations comprising performing, via the transceiver, a first measurement. The processor may also perform operations comprising determining whether a condition is met based on the first measurement. The processor may further perform operations comprising triggering a mobility procedure during a connection establishment procedure or a connection resume procedure in an event that the condition is met.

In one aspect, a method may involve a network node receiving an RRC complete message from a UE. The method may also involve the network node determining whether a mobility procedure is indicated in the RRC complete message. The method may further involve the network node initiating a reporting procedure for acquiring measurement results from the UE in an event that the mobility procedure is indicated in the RRC complete message.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1A is a diagram depicting example scenarios under schemes in accordance with implementations of the present disclosure.

FIG. 1B is a diagram depicting an example scenario under schemes in accordance with implementations of the present disclosure.

FIG. 2A is a diagram depicting an example scenario under schemes in accordance with implementations of the present disclosure.

FIG. 2B is a diagram depicting an example scenario under schemes in accordance with implementations of the present disclosure.

FIG. 3A is a diagram depicting an example scenario under schemes in accordance with implementations of the present disclosure.

FIG. 3B is a diagram depicting an example scenario under schemes in accordance with implementations of the present disclosure.

FIG. 4A is a diagram depicting an example scenario under schemes in accordance with implementations of the present disclosure.

FIG. 4B is a diagram depicting an example scenario under schemes in accordance with implementations of the present disclosure.

FIG. 5 is a diagram depicting an example process0 under schemes in accordance with implementations of the present disclosure.

FIG. 6 is a diagram depicting an example process in accordance with implementations of the present disclosure.

FIG. 7 is an example communication system having an example communication apparatus and an example network apparatus in accordance with an implementation of the present disclosure.

FIG. 8 is a flowchart of an example process in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to early mobility and reporting procedures in the cell edge in mobile communications. According to the present disclosure, a number of possible solutions may be implemented separately or jointly. That is, although these possible solutions may be described below separately, two or more of these possible solutions may be implemented in one combination or another.

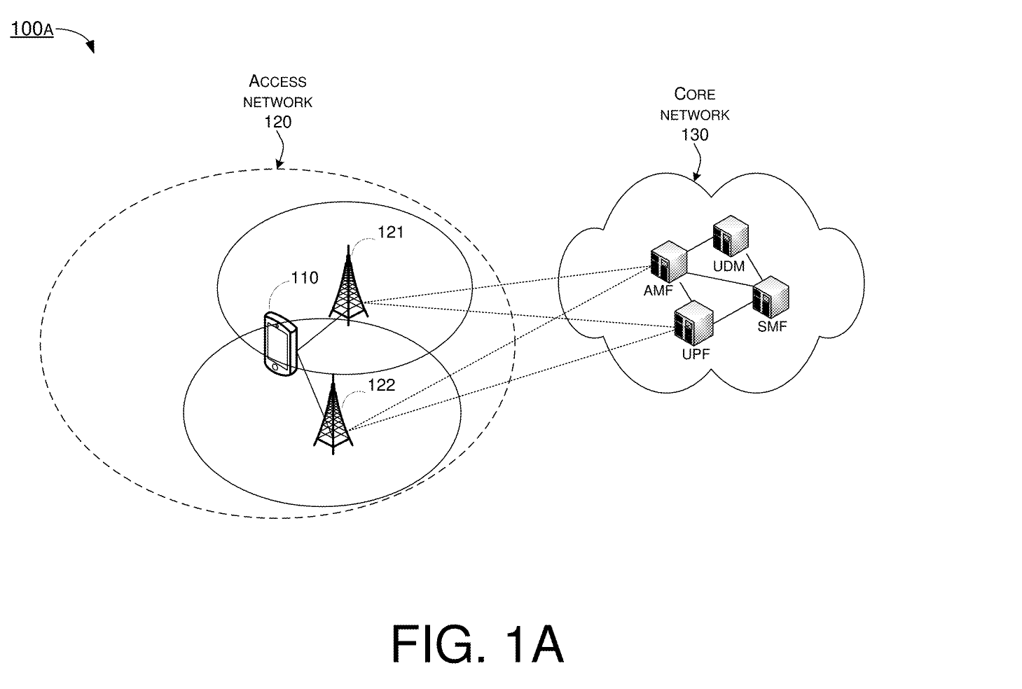

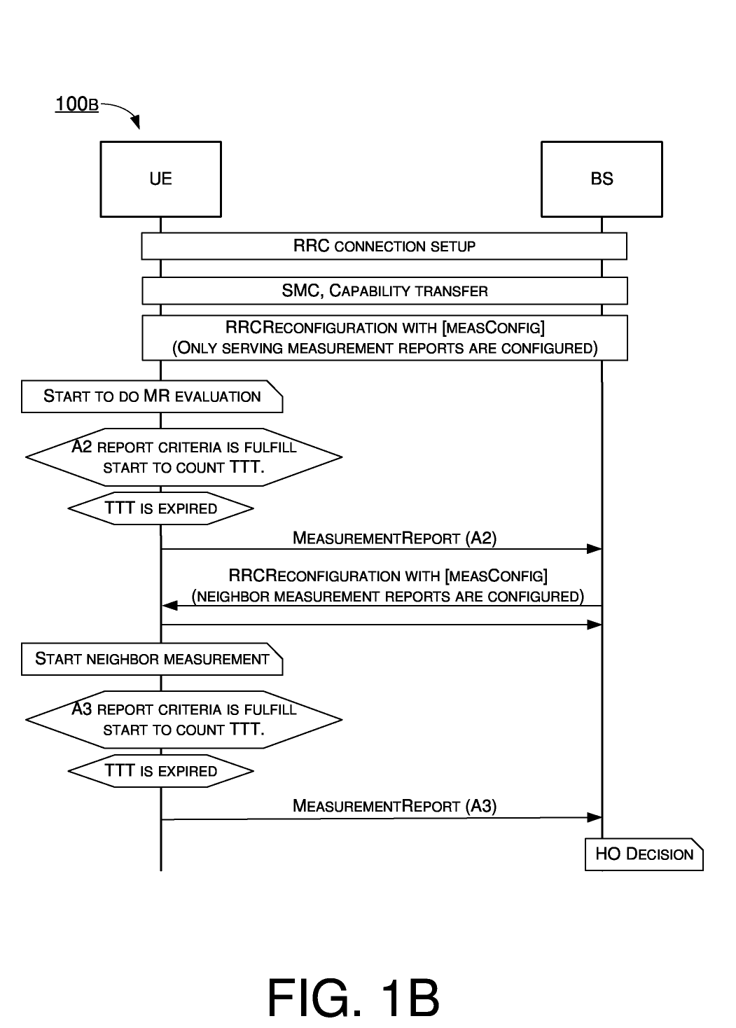

FIG. 1A illustrates an example scenario 100a of a communication environment in which various solutions and schemes in accordance with the present disclosure may be implemented. Scenario 100a involves a user equipment (UE) 110 in wireless communication with a wireless network (e.g., an LTE network, a 5G/NR network, an IoT network, or a 6G network) consisting of an access network 120 and a core network 130. The UE 110 may be a smart phone, a wearable device, an IoT device, and a tablet, etc. Alternatively, the UE 110 may be a notebook (NB) or personal computer (PC) inserted or installed with a data card which includes a modem and radio frequency (RF) transceiver(s) to provide the functionality of wireless communication. In one embodiment, the access network 120 is connected to the core network 130 by means of the NG interface, more specifically to a user plane function (UPF) by means of the NG user-plane part (NG-u), and to an access and mobility management function (AMF) by means of the NG control-plane part (NG-c). The access network 120 may include a network node 121 and a network node 122, which may be connected to multiple UPFs/AMFs respectively for the purpose of load sharing and redundancy. The network node may be called a base station (BS) or a cell. In addition, the core network may include other entities, such as a session management function (SMF) and a unified data management (UDM), etc. As illustrated, the access network 120 may include multiple BSs (e.g., network nodes 121, 122), each of which may provide communication coverage for a geographic coverage area where communications with the UE 110 are supported. The UE 110 may perform a connection establishment procedure (e.g., radio resource control (RRC) connection establishment procedure) to transition from an idle state (i.e., RRC_Idle mode) to a connected state (i.e., RRC_Connected mode) with a serving cell (e.g., network node 121), or may perform an RRC resume procedure to transition from an inactive state (i.e., RRC_Inactive mode) to the connected state with the serving cell (e.g., network node 121). For illustrative purposes, two network nodes (i.e., network nodes 121, 122) and one UE (UE 110) may be described hereinafter. However, it is not intended to limit the network scenarios of the present disclosure.

In the idle state or the inactive state, the UE 110 may perform cell reselection procedure to get connected to a cell which has the better condition among all the cells. The UE 110 may perform the cell reselection procedure to a new cell in an event that a reselection criterion is met during a time interval Treselection and more than 1 second has elapsed since the UE 100 camped on the current serving cell. However, a better cell may be available for reselection, but the UE 110 may initiate the connection setup/resume procedure before the reselection occurs.

FIG. 1B is a diagram depicting an example scenario 100b of a general mobility procedure. In the connected state (connected mode), mobility may rely on a measurement report (MR) from the UE 110. After the UE and the BS finish an RRC complete connection setup, a security protection procedure, and capability transfer, the network (NW) (i.e., gNB) may first configure serving cell measurement report to the UE by an RRC reconfiguration message (e.g., an RRCReconfiguration with measConfig). The serving cell measurement report may be triggered by events A1 and A2 (i.e., predefined measurement report types). At this stage, the NW (i.e., gNB) may only configure serving cell measurement. The UE may start to perform MR evaluation. When a report criterion (e.g., A2 report criterion) is fulfilled, the UE may start a counter with a full Time-To-Trigger (TTT) value (e.g., a predefined TTT 320 ms configured by the NW or predetermined by the UE). Then the UE may send the serving cell measurement report (e.g., A2 report) to the NW (i.e., gNB) in an event that the counter expires (i.e., TTT expires). Once the UE sends the A2 report, the NW (i.e., gNB) may configure neighbor cell measurement reports (e.g., A3, A4, A5, B1, B2) by the RRC reconfiguration (e.g., the RRCReconfiguration with measConfig). The UE may start measurement(s) on at least one neighbor cell(s). When a report criterion (e.g., A3 report criterion) is fulfilled, the UE may start a counter with a full TTT value (e.g., a predefined TTT 320 ms configured by the NW or predetermined by the UE). Then the UE may send the neighbor cell measurement report (e.g., A3 report) to the NW (i.e., gNB) in an event that the counter expires (i.e., TTT expires). After the UE sends the neighbor cell measurement report, the NW may determine to trigger corresponding mobility procedures (e.g., handover (HO), redirection, or lower-layer triggered mobility (LTM)). In this case, the mobility procedures decision is made after 2 measurement reports and 1 reconfiguration procedure. It might cause a too-late handover problem or a connection setup failure, especially in cases where the UE is at the edge of the current serving cell (e.g., the edge of the communication coverage of the serving cell).

While the UE 110 is in an idle/inactive state and moves to the cell edge of the current serving cell, a certain neighbor cell may have met at least part of the cell reselection criterion (e.g., signal strength or signal quality of a neighboring cell is higher than a first threshold, and/or signal strength or signal quality of the serving cell is lower than a second threshold), but the cell reselection hasn’t been performed. That is because part of the reselection criterion is met during a time interval, but less than Treselection (i.e., a duration that the UE must detect a better signal from a neighboring cell before actually switching to the neighboring cell), or less than 1 second has elapsed since the UE 110 camped on the current serving cell. If the UE 110 establishes/resumes a connection and enters connected mode before the cell reselection begins, mobility of the UE may rely on the network’s configuration and decisions. The transition to a better cell may be delayed. Consequently, triggering of the mobility procedure may be delayed, potentially resulting in a radio link failure (RLF).

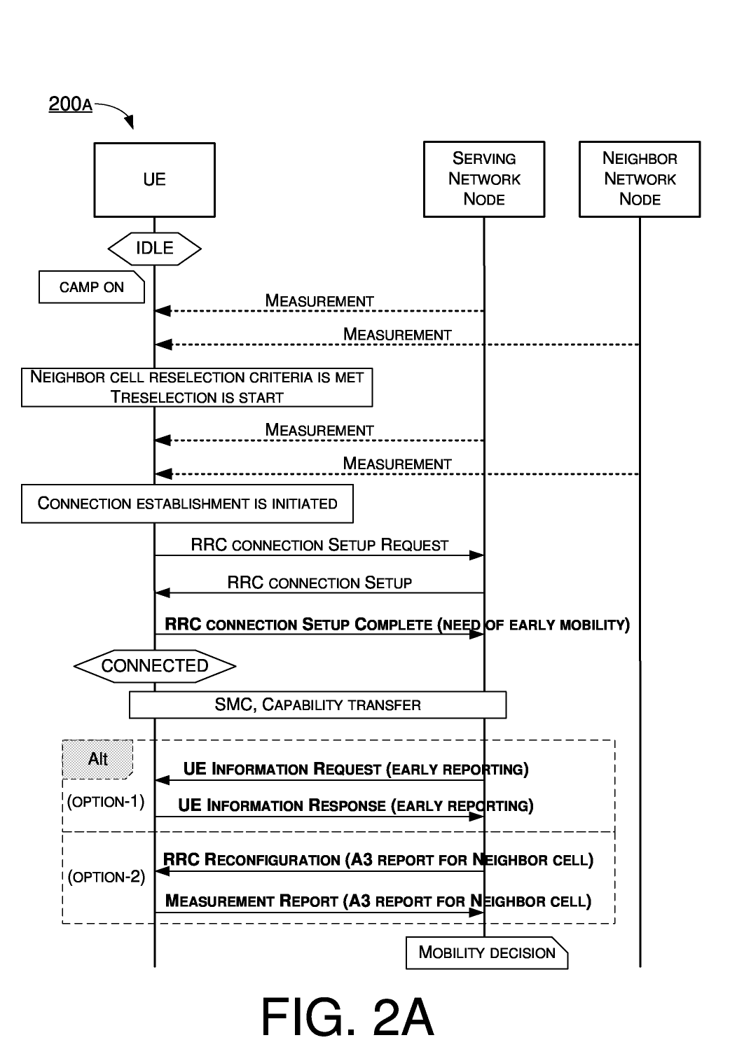

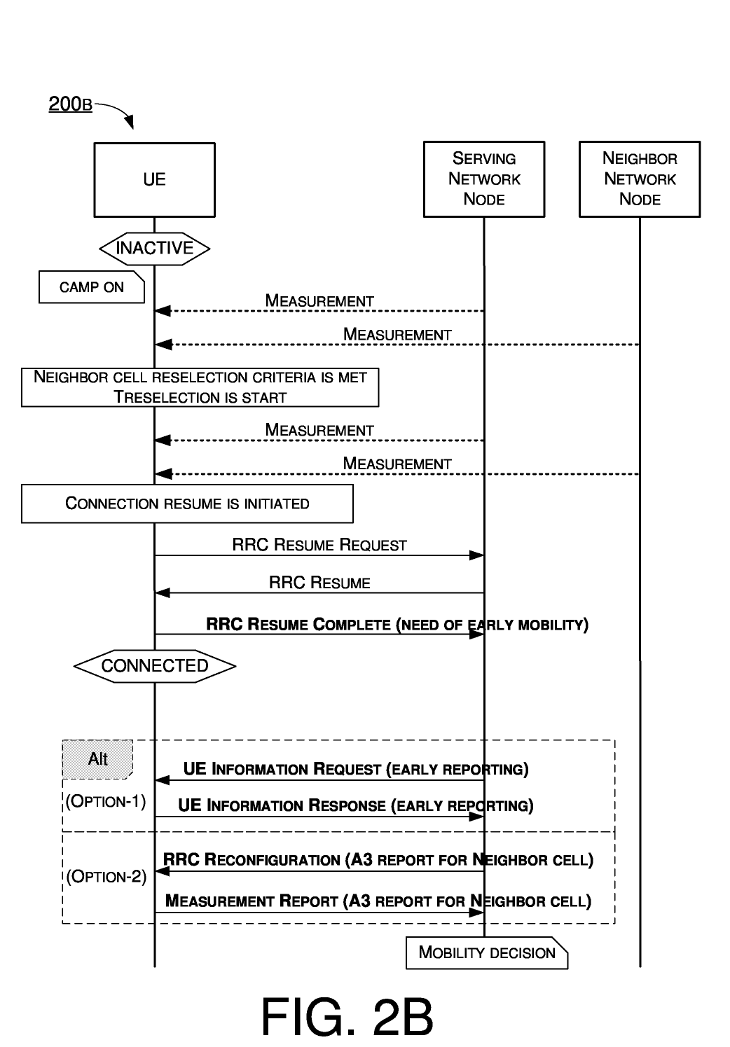

FIGS. 2A, 3A, 4A and 4B are diagrams depicting example scenarios of early mobility and reporting procedures in the cell edge in accordance with implementations of the present disclosure. Scenario 200a in FIG. 2A shows the early mobility and reporting procedures where the UE performs a connection establishment procedure to transition from an idle state to a connected state. In the idle state, the UE camps on a serving network node (i.e., a serving cell) with a 1s timer running. The UE in the idle state may perform measurements on both the serving network node (i.e., the serving cell) and one or more neighbor network nodes (i.e., the neighbor cell) before initiating the connection establishment procedure. After performing the measurements on the serving cell and the neighbor cell, the UE may determine whether any of the one or more neighbor network nodes meet a neighbor cell criterion or not (e.g., the UE may determine whether signal strength or signal quality of any of the one or more neighbor network nodes is greater than a threshold). In one example, the UE may determine the neighbor network node meet the neighbor cell criterion in an event that a neighboring cell signal strength or a neighboring cell signal quality is greater than a threshold but has not yet meet a time interval Treselection (i.e., the time that the neighboring cell signal strength or the neighboring cell signal quality being greater than the threshold is less than Treselection). A Treselection timer may start in an event that a neighboring cell signal strength or a neighboring cell signal quality is greater than a threshold. In one example, the UE may determine the neighbor network node meet the neighbor cell criterion in an event that a neighboring cell signal strength or a neighboring cell signal quality is greater than a threshold and has met a time interval Treselection (i.e., the time that the neighboring cell signal strength or the neighboring cell signal quality being greater than the threshold is equal to or greater than Treselection) but no more than 1 second has elapsed since the UE camped on the serving cell. In one example, the UE may determine whether any of the one or more neighbor network nodes meets a neighbor cell criterion or not and further determine whether a signal strength or a signal quality of serving signal (e.g., reference signal received power (RSRP), reference signal received quality (RSRQ), signal to interference plus noise ratio (SINR), etc.) for measuring the serving network node (i.e., the serving cell) is lower than a certain threshold (e.g., an RSRP threshold, an RSRQ threshold, an SINR threshold, etc.) or not. The UE may determine that it is in the edge of the serving cell in an event that the signal strength or the signal quality of the serving signal (e.g., RSRP, RSRQ, SINR, etc.) is lower than a certain threshold. In one example, the NW (e.g., the serving cell) may configure the certain threshold. In one example, the certain threshold may be determined by the UE. In some cases, the UE may determine at least one neighbor cell better than the serving cell before initiating the connection establishment procedure. In one example, the UE may trigger an early mobility procedure during a connection establishment procedure in an event that a neighbor network node has met the neighbor cell criterion (e.g., a neighboring cell signal strength or a neighboring cell signal quality is greater than a threshold but has not yet meet a time interval Treselection, or a neighboring cell signal strength or a neighboring cell signal quality is greater than a threshold and has met a time interval Treselection but no more than 1 second has elapsed since the UE camped on the serving cell). In one example, the UE may trigger the early mobility procedure during the connection establishment procedure in an event that a neighbor network node has met the neighbor cell criterion (e.g., a neighboring cell signal strength or a neighboring cell signal quality is greater than a threshold but has not yet meet a time interval Treselection, or a neighboring cell signal strength or a neighboring cell signal quality is greater than a threshold and has met a time interval Treselection but no more than 1 second has elapsed since the UE camped on the serving cell) and the UE is in the edge of the serving cell (e.g., a serving cell signal strength or a serving cell signal quality is lower than a certain threshold).

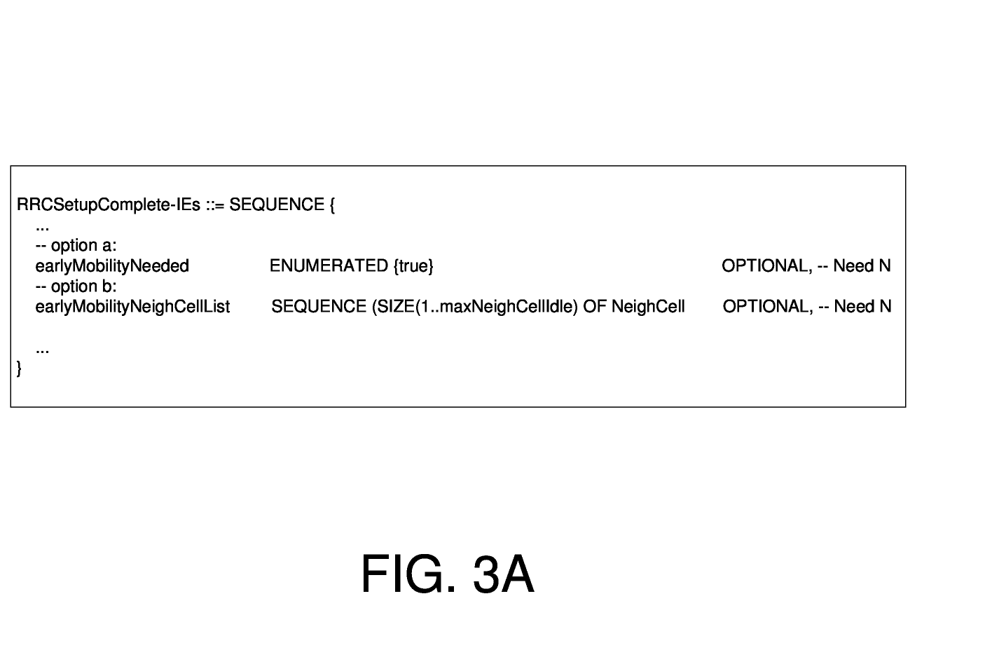

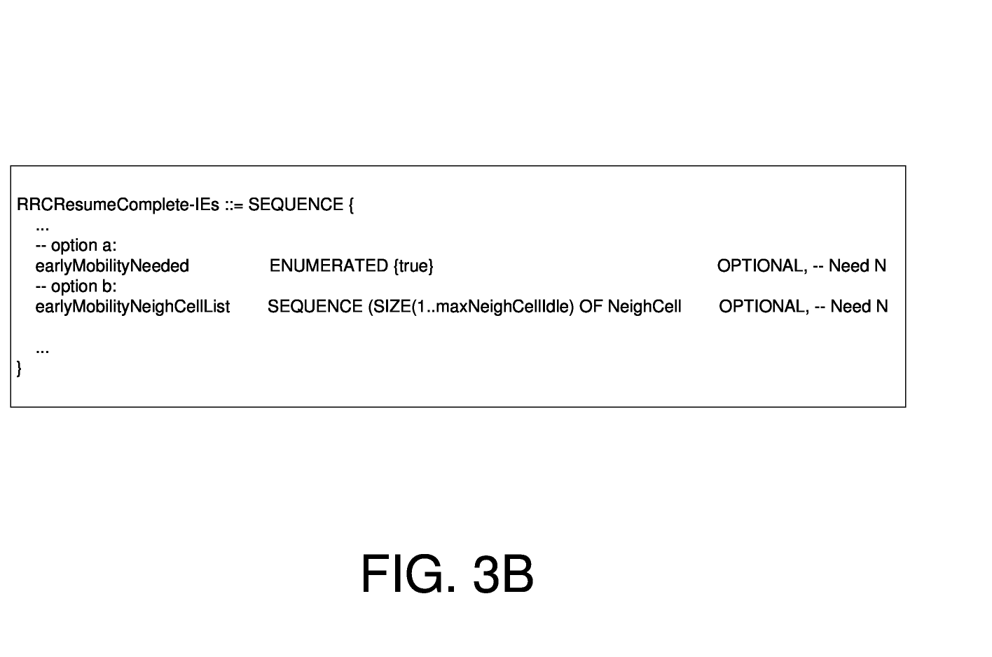

Then the UE may initiate the connection establishment procedure with the serving network node (i.e., the serving cell) and send an RRC connection setup request message to the serving cell. Then the serving cell may send an RRC connection setup message to the UE after receiving the RRC connection setup request message. After receiving the RRC connection setup message, the UE may indicate an early mobility procedure in an RRC connection setup complete message in an event that the neighbor network node has met a reselection criterion (e.g., the neighbor cell criterion) and then may transmit the RRC connection setup complete message to the serving cell. In one embodiment, the UE may indicate or include a need of early mobility in the RRC connection setup complete message (e.g., earlyMobilityNeeded and earlyMobilityNeighCellList illustrated in FIG. 3A). In one example, the UE may indicate a flag (e.g., earlyMobilityNeeded illustrated in FIG. 3A) in the RRC complete message, and the flag may indicate whether signal strength or signal quality of the neighbor network node is higher or greater than a threshold or not. In one example, the UE may indicate a list (e.g., earlyMobilityNeighCellList illustrated in FIG. 3A) in the RRC complete message, and the list may include or list the neighbor network node(s) that its signal strength or signal quality is higher or greater than a threshold. In one example, the UE may indicate the flag and the list in the RRC complete message. The serving network node (i.e., the serving cell) may receive the RRC complete message and then may enter the connected state (e.g., RRC connected mode). Then the serving cell may activate a security protection procedure with the UE and perform capability transfer with the UE.

After activating the security protection procedure and performing the capability transfer with the UE, the serving cell may determine whether the early mobility procedure is indicated in the RRC complete message or not. The serving cell may perform an early reporting procedure to retrieve a measurement result of a first neighbor network node from the UE in an event that the early mobility procedure is indicated in the RRC complete message. The first neighbor network node may be a neighbor network node indicated in the RRC complete message (e.g., a neighbor network node indicated in earlyMobilityNeeded or earlyMobilityNeighCellList illustrated in FIG. 3A).

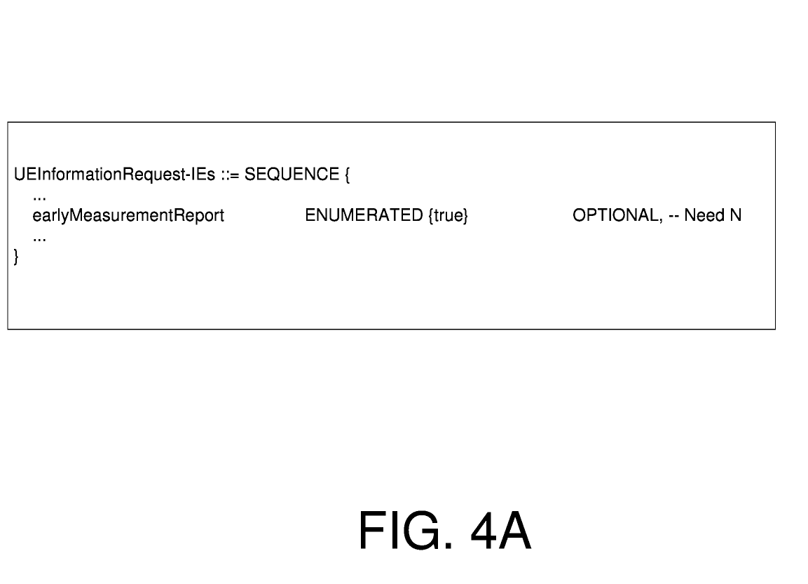

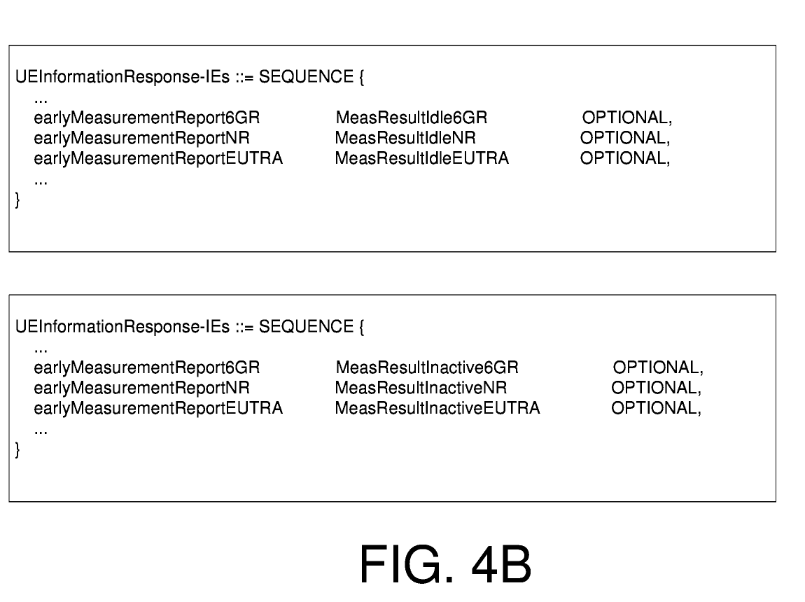

There are several design options (e.g., option-1 and option-2 illustrated in FIG. 2A) for the serving cell performing the early reporting procedure to retrieve the measurement result of the first neighbor network node; however, the present disclosure is not limited thereto. In one embodiment, illustrated as FIG. 2A option-1, the serving cell may transmit a UE information request message to the UE. The UE information request message may include or indicate an early reporting message or an early reporting indication (e.g., earlyMeasurementReport illustrated in FIG. 4A). The UE information request message may be an information element UEInformationRequest illustrated in FIG. 4A. After receiving the UE information request message, the UE may transmit a UE information response message to the serving cell. The UE information response message may include a measurement report including measurement results of the neighbor cell(s) and/or the serving cell (e.g., earlyMeasurementReport6GR/MeasResultIdle6GR, earlyMeasurementReportNR/MeasResultIdleNR, earlyMeasurementReportEUTRA/MeasResultIdleEUTRA illustrated in FIG. 4B), which is gathered by the UE in the idle state. In one example, the measurement report, which is gathered by the UE in the idle state, may include measurement results of the neighbor cell(s) and the serving cell. In one example, the measurement report, which is gathered by the UE in the idle state, may include measurement results of the neighbor cell(s). Accordingly, the serving cell may retrieve an early measurement report through the measurement results gathered while the UE is in the idle state.

In one embodiment, illustrated as FIG. 2A option-2, the serving cell may configure an RRC reconfiguration to retrieve measurement results of the neighbor cell(s) and/or the serving cell (e.g., A3, A4, A5, B1, B2 reports). After receiving the RRC reconfiguration, the UE may perform neighbor cell measurement and/or serving cell measurement according to the RRC reconfiguration. Then the UE may transmit a measure report (e.g., A3 report for a neighbor cell) to the serving cell. In some embodiments, the UE may perform neighbor cell measurement and/or serving cell measurement with a zero Time-To-Trigger (TTT) value or a shorter TTT value compared to a previous TTT value (e.g., 0, 40, 64, 80, … etc.) according to the RRC reconfiguration. In one example, a full or default Time-To-Trigger (e.g. for legacy A3 measurement) may be 320 ms, and the shorter Time-To-Trigger for option-2 may be 40 ms. In one example, a full or default Time-To-Trigger (e.g. for legacy A3 measurement) may be 320 ms, and the shorter Time-To-Trigger for option-2 may be 64 ms. In one example, a full or default Time-To-Trigger (e.g. for legacy A3 measurement) may be 320 ms, and the shorter Time-To-Trigger for option-2 may be 84 ms. In one example, the serving cell may configure the zero or shorter Time-To-Trigger value which is less than the full or default Time-To-Trigger value (i.e., a previous Time-To-Trigger) in the RRC reconfiguration. In one example, the Time-To-Trigger value may be determined by the UE. Accordingly, the serving cell may retrieve an early measurement report through the shorter or zero Time-To-Trigger value. In one example, the measurement report may include measurement results of the neighbor cell(s) and the serving cell. In one example, the measurement results may include measurement results of the neighbor cell(s).

After performing the early reporting procedure illustrated above, the serving cell may make a mobility decision accordingly.

FIGS. 2B, 3B, 4A and 4B are diagrams depicting example scenarios of early mobility and reporting procedures in the cell edge in accordance with implementations of the present disclosure. Scenario 200b in FIG. 2B shows the early mobility and reporting procedures where the UE performs a connection resume procedure to transition from an inactive state to a connected state. The UE in the inactive state may perform measurements on both the serving network node (i.e., the serving cell) and one or more neighbor network nodes (i.e., the neighbor cell) before initiating the connection resume procedure. After performing the measurements on the serving cell and the neighbor cell, the UE may determine whether any of the one or more neighbor network nodes meet a neighbor cell criterion or not (e.g., the UE may determine whether signal strength or signal quality of any of the one or more neighbor network nodes is greater than a threshold). In one example, the UE may determine the neighbor network node meet the neighbor cell criterion in an event that a neighboring cell signal strength or a neighboring cell signal quality is greater than a threshold but has not yet meets a time interval Treselection. A Treselection timer may start in an event that a neighboring cell signal strength or a neighboring cell signal quality is greater than a threshold. In one example, the UE may determine the neighbor network node meet the neighbor cell criterion in an event that a neighboring cell signal strength or a neighboring cell signal quality is greater than a threshold and has met a time interval Treselection but no more than 1 second has elapsed since the UE camped on the serving cell. In one example, the UE may determine whether any of the one or more neighbor network nodes meet a neighbor cell criterion or not and further determine whether a signal strength or a signal quality of the serving signal (e.g., RSRP, RSRQ, SINR, etc.) for measuring the serving network node (i.e., the serving cell) is lower than a certain threshold or not. The UE may determine it is in the edge of the serving cell in an event that the signal strength or the signal quality of the serving signal (e.g., RSRP, RSRQ, SINR, etc.) for measuring the serving cell is lower than a certain threshold. In one example, the NW (e.g., the serving cell) may configure the certain threshold. In one example, the certain threshold may be determined by the UE. In some cases, the UE may determine at least one neighbor cell better than the serving cell before initiating the connection resume procedure. In one example, the UE may trigger an early mobility procedure during a connection resume procedure in an event that a neighbor network node has met a reselection criterion (e.g., the neighbor cell criterion (e.g., a neighboring cell signal strength or a neighboring cell signal quality is greater than a threshold but has not yet meet a time interval Treselection, or a neighboring cell signal strength or a neighboring cell signal quality is greater than a threshold and has met a time interval Treselection but no more than 1 second has elapsed since the UE camped on the serving cell)). In one example, the UE may trigger the early mobility procedure during the connection resume procedure in an event that a neighbor network node has met the neighbor cell criterion (e.g., a neighboring cell signal strength or a neighboring cell signal quality is greater than a threshold but has not yet meets a time interval Treselection, or a neighboring cell signal strength or a neighboring cell signal quality is greater than a threshold and has met a time interval Treselection but no more than 1 second has elapsed since the UE camped on the serving cell) and the UE is in the edge of the serving cell (e.g., a serving cell signal strength or a serving cell signal quality is lower than a certain threshold).

Then the UE may initiate the connection resume procedure with the serving network node (i.e., the serving cell) and send an RRC resume request message to the serving cell. Then the serving cell may transmit an RRC resume message to the UE after receiving the RRC resume request message. After receiving the RRC resume message, the UE may indicate an early mobility procedure in an RRC resume complete message in an event that the neighbor network node has met the reselection criterion, and then may transmit the RRC resume complete message to the serving cell. In one embodiment, the UE may indicate or include a need of early mobility in the RRC resume complete message (e.g., earlyMobilityNeeded and earlyMobilityNeighCellList illustrated in FIG. 3B). In one example, the UE may indicate a flag (e.g., earlyMobilityNeeded illustrated in FIG. 3B) in the RRC resume complete message, and the flag may indicate whether signal strength or signal quality of the neighbor network node is higher or greater than a threshold or not. In one example, the UE may indicate a list (e.g., earlyMobilityNeighCellList illustrated in FIG. 3B) in the RRC resume complete message, and the list may include or list the neighbor network node(s) whose signal strength or signal quality is higher or greater than a threshold. In one example, the UE may indicate the flag and the list in the RRC resume complete message. The serving network node (i.e., the serving cell) may receive the RRC resume complete message and then may enter the connected state (e.g., RRC connected mode). Then the serving cell may activate a security protection procedure with the UE and perform capability transfer with the UE.

After activating the security protection procedure and performing the capability transfer with the UE, the serving cell may determine whether the early mobility procedure is indicated in the RRC complete message or not. The serving cell may perform an early reporting procedure to retrieve a measurement result of a first neighbor network node from the UE in an event that the early mobility procedure is indicated in the RRC complete message, wherein the first neighbor network node may be a neighbor network node indicated in the RRC resume complete message (e.g., a neighbor network node indicated in earlyMobilityNeeded or earlyMobilityNeighCellList illustrated in FIG. 3B).

There are several design options (e.g., option-1 and option-2 illustrated in FIG. 2B) for the serving cell performing the early reporting procedure to retrieve the measurement result of the first neighbor network node; however, the present disclosure is not limited thereto. In one embodiment, illustrated as FIG. 2B option-1, the serving cell may transmit a UE information request message to the UE. The UE information request message may include or indicate an early reporting message or an early reporting indication (e.g., earlyMeasurementReport illustrated in FIG. 4A). The UE information request message may be an information element UEInformationRequest illustrated in FIG. 4A. After receiving the UE information request message, the UE may transmit a UE information response message to the serving cell. The UE information response message may include a measurement report including measurement results of the neighbor cell(s) and/or the serving cell (e.g., earlyMeasurementReport6GR/MeasResultInactive6GR, earlyMeasurementReportNR/MeasResultInactiveNR, earlyMeasurementReportEUTRA/MeasResultInactiveEUTRA illustrated in FIG. 4B), which is gathered by the UE in the inactive state. In one example, the measurement report, which is gathered by the UE in the inactive state, may include measurement results of the neighbor cell(s) and the serving cell. In one example, the measurement report that is gathered by the UE in the inactive state may include measurement results of the neighbor cell(s). Accordingly, the serving cell may retrieve an early measurement report through the measurement results gathered while the UE in the inactive state.

In one embodiment, illustrated as FIG. 2B option-2, the serving cell may configure an RRC reconfiguration to retrieve measurement results of the neighbor cell(s) and/or the serving cell (e.g., A3, A4, A5, B1, B2 reports). After receiving the RRC reconfiguration, the UE may perform neighbor cell measurement and/or serving cell measurement according to the RRC reconfiguration. Then the UE may transmit a measure report (e.g., A3 report for a neighbor cell) to the serving cell. In one example, the UE may perform neighbor cell measurement and/or serving cell measurement with a shorter or zero Time-To-Trigger value (e.g., 0, 40, 64, 80, … etc.) according to the RRC reconfiguration. In one example, a full or default Time-To-Trigger (e.g. for legacy A3 measurement) may be 320 ms, and the shorter Time-To-Trigger for option-2 may be 40 ms. In one example, a full or default Time-To-Trigger (e.g. for legacy A3 measurement) may be 320 ms, and the shorter Time-To-Trigger for option-2 may be 64 ms. In one example, a full or default Time-To-Trigger (e.g. for legacy A3 measurement) may be 320 ms, and the shorter Time-To-Trigger for option-2 may be 84 ms. In one example, the serving cell may configure the zero or shorter Time-To-Trigger value which is less than the full or default Time-To-Trigger value in the RRC reconfiguration. In one example, the Time-To-Trigger value may be determined by the UE. Accordingly, the serving cell may retrieve an early measurement report through the shorter or zero Time-To-Trigger value. In one example, the measurement report may include measurement results of the neighbor cell(s) and the serving cell. In one example, the measurement results may include measurement results of the neighbor cell(s).

After performing the early reporting procedure illustrated above, the serving cell may make a mobility decision accordingly.

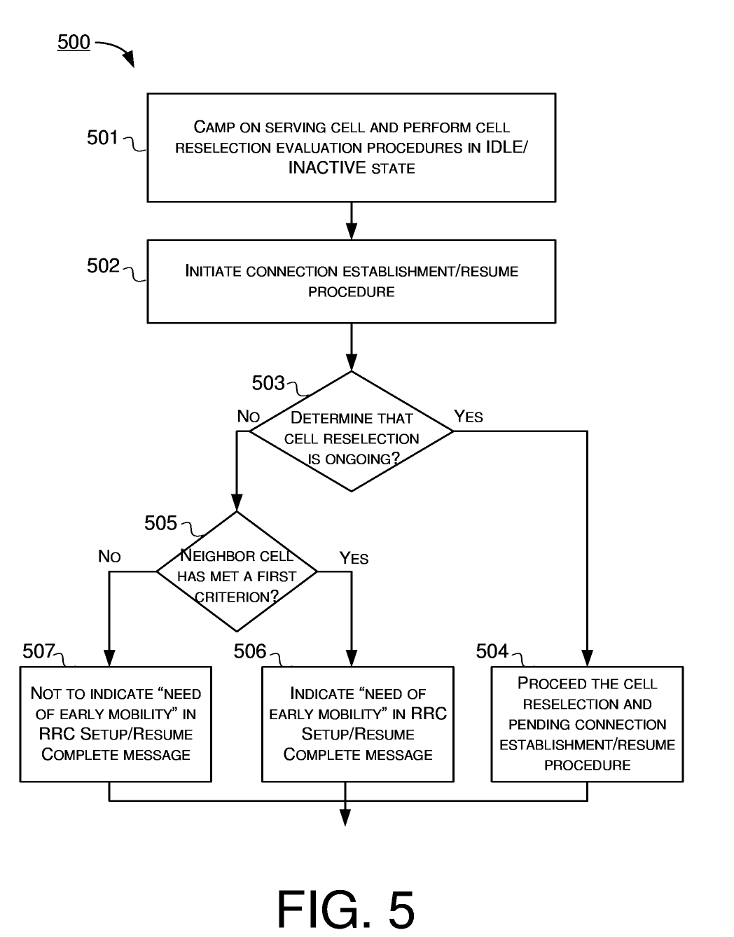

FIG. 5 is a diagram depicting an example process 500 of UE performing early mobility and reporting procedures under schemes in accordance with implementations of the present disclosure. The process 500 may proceed from step 501 to step 507.

In step 501, the UE may camp on a serving cell and may perform cell reselection evaluation procedures in an IDLE state or in an INACTIVE state. Then the process proceeds to step 502.

In step 502, the UE may initiate a connection establishment procedure or a connection resume procedure. Then the process proceeds to step 503.

In step 503, the UE may determine whether a cell reselection is ongoing or not. If yes, the process proceeds to step 504; otherwise, the process proceeds to step 505.

In step 504, the UE may continue the cell reselection, and the UE may pend the connection establishment procedure or the connection resume procedure.

In step 505, the UE may determine whether at least one neighboring cell has met a first criterion (e.g., the neighboring cell criterion). In another example, the UE may determine whether at least one neighboring cell has met the first criterion (e.g., a neighboring cell signal strength or a neighboring cell signal quality is greater than a threshold but has not yet meet a time interval Treselection, or a neighboring cell signal strength or a neighboring cell signal quality is greater than a threshold and has met a time interval Treselection but no more than 1 second has elapsed since the UE camped on the serving cell) and a signal strength or a signal quality of a serving cell (e.g., RSRP, RSRQ, SINR, etc.) is lower than a certain threshold. If yes, the process proceeds to step 506; otherwise, the process proceeds to step 507.

In step 506, the UE may indicate “need of early mobility” in an RRC connection setup complete message or an RRC connection resume complete message. In one example, the UE may indicate an indication “need of early mobility” as “true” in the RRC connection setup complete message or the RRC connection resume complete message.

In step 507, the UE may not indicate “need of early mobility” in the RRC connection setup complete message or the RRC connection resume complete message. In another example, the UE may indicate an indication “need of early mobility” as “false” in the RRC connection setup complete message or the RRC connection resume complete message.

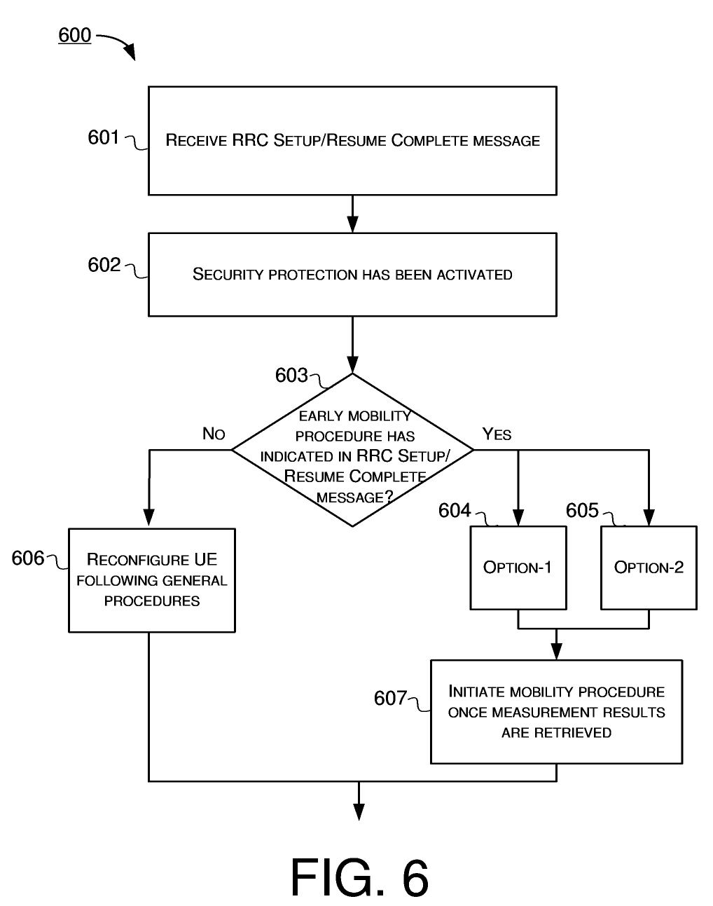

FIG. 6 is a diagram depicting an example process 600 of NW performing early mobility and reporting procedures in accordance with implementations of the present disclosure. The process 600 may proceed from step 601 to step 607.

In step 601, the NW may receive an RRC connection setup/resume complete message. Then the process proceeds to step 602.

In step 602, the NW may determine whether a security protection procedure has been activated or not. If yes, the process proceeds to step 603.

In step 603, the NW may determine whether an early mobility procedure has been indicated in the RRC setup/resume complete message or not. If yes, the process proceeds to step 604 or step 605; otherwise, the process proceeds to step 606.

In step 604, the NW may initiate UE Information procedures to acquire the UE measurement results measured in the idle state or in the inactive state (option-1). Then the process proceeds to step 607.

In step 605, the NW may reconfigure the UE to trigger an earlier measurement report (e.g., the NW may configure serving and neighbor measurement with zero or shorter TTT (e.g., 0 ms, 40 ms, 64 ms, 80 ms, etc.)) (option-2). Then the process proceeds to step 607.

In step 606, the NW may reconfigure the UE following general procedures (e.g., the NW may first configure serving cell measurement only, and the serving measurement may be performed with a normal TTT value (e.g., 320 ms)).

In step 607, the NW may initiate a mobility procedure after the measurement results are retrieved from step 604 or from step 605.

### Illustrative Processes

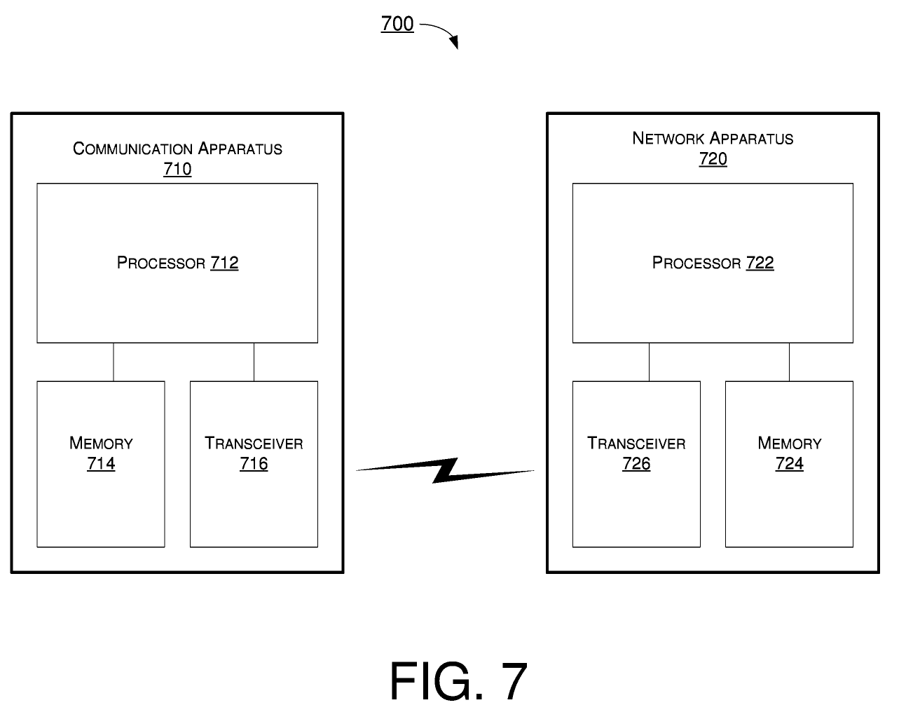

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to early mobility and reporting procedures in the cell edge with respect to UE and network apparatus in mobile communications, including scenarios/schemes described above as well as processes 800 and 900 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, a digital camera, or a computing equipment such as a tablet computer, a laptop computer or a notebook computer. Communication apparatus 710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed scheme of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of a network apparatus, which may be a network node such as a satellite, a base station, a small cell, a router or a gateway. For instance, network apparatus 720 may be implemented in an eNodeB in an LTE network, in a gNB in a 5G/NR, IoT, NB-IoT or IIoT network or in a satellite or base station in a 6G network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including early mobility and reporting procedures in the cell edge in a device (e.g., as represented by communication apparatus 710) and a network (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In other words, processor 712 may transceive the data such as configuration, message, signal, information, indicator, etc. via transceiver 716. Transceiver 716 may include an MR and an LR. In some implementations, communication apparatus 710 may further include a memory 714 coupled to processor 712 and capable of being accessed by processor 712 and storing data therein. In some implementations, network apparatus 720 may also include a transceiver 726 coupled to processor 722 and capable of wirelessly transmitting and receiving data. In other words, processor 722 may transceive the data such as configuration, message, signal, information, indicator, etc. via transceiver 726. In some implementations, network apparatus 720 may further include a memory 724 coupled to processor 722 and capable of being accessed by processor 722 and storing data therein. Accordingly, communication apparatus 710 and network apparatus 720 may wirelessly communicate with each other via transceiver 716 and transceiver 726, respectively. To aid better understanding, the following description of the operations, functionalities and capabilities of each of communication apparatus 710 and network apparatus 720 is provided in the context of a mobile communication environment in which communication apparatus 710 is implemented in or as a communication apparatus or a UE and network apparatus 720 is implemented in or as a network node of a communication network.

In some implementations, each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

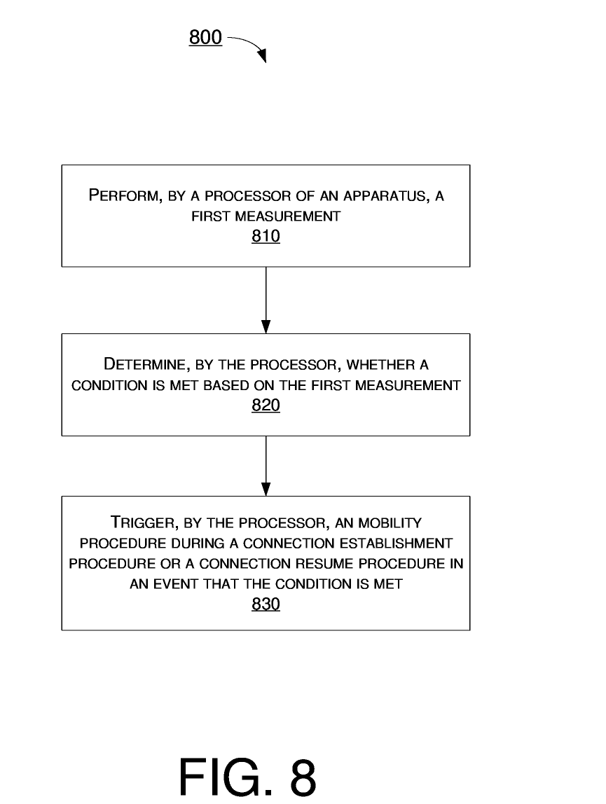

FIG. 8 illustrates an example process 800 in accordance with an implementation of the present disclosure. Process 800 may be an example implementation of above scenarios/schemes, whether partially or completely, with respect to early mobility and reporting procedures in the cell edge of the present disclosure. Process 800 may represent an aspect of implementation of features of communication apparatus 710. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by communication apparatus 710 or any suitable UE or machine type devices. Solely for illustrative purposes and without limitation, process 800 is described below in the context of communication apparatus 710. Process 800 may begin at block 810.

At block 810, process 800 may involve processor 712 of communication apparatus 710 performing a first measurement. In one example, the first measurement may include a measurement on a neighbor cell and a measurement on a serving cell in an idle mode or an inactive mode. In one example, the first measurement may include a measurement on a neighbor cell in the idle mode or the inactive mode. Process 800 may proceed from block 810 to block 820.

At block 820, process 800 may involve processor 712 of communication apparatus 710 determining whether a condition is met based on the first measurement. Process 700 may proceed from block 820 to block 830.

At block 830, process 800 may involve processor 712 of communication apparatus 710 triggering a mobility procedure (e.g., an early mobility procedure) during a connection establishment procedure or a connection resume procedure in an event that the condition is met.

In some implementations, the condition may include at least one of that signal strength or signal quality of a neighboring cell is higher than a first threshold and that signal strength or signal quality of a serving cell signal is lower than a second threshold.

In some implementations, the condition may include signal strength or signal quality of a neighboring cell is higher than a first threshold but has not yet meets a time interval (e.g., Treselection), or the signal strength or the signal quality of the neighboring cell is higher than the first threshold and has met a time interval but no more than 1 second has elapsed since the apparatus camped on a serving cell.

In some implementations, process 800 may involve processor 712 of communication apparatus 710 indicating a need of the mobility procedure (e.g., the mobility procedure) in an RRC complete message during the connection establishment procedure or the connection resume procedure. The process 800 may also involve processor 712 of communication apparatus 710 transmitting, via transceiver 716, the RRC complete message to a serving cell.

In some implementations, wherein the RRC complete message is an RRC connection setup complete message or an RRC connection resume complete message.

In some implementations, process 800 may involve processor 712 of communication apparatus 710 receiving, via transceiver 716, a UE information request from the serving cell after triggering the mobility procedure (e.g., the mobility procedure). The process 800 may also involve processor 712 of communication apparatus 710 transmitting, via transceiver 716, a UE information response to the serving cell. The UE information response may include a measurement result of the first measurement.

In some implementations, process 800 may involve processor 712 of communication apparatus 710 receiving, via transceiver 716, an RRC reconfiguration from the serving cell after triggering the mobility procedure (e.g., the mobility procedure). The process 800 may also involve processor 712 of communication apparatus 710 performing a second measurement on the neighbor cell with a zero time-to-trigger (TTT) value or a shorter TTT value compared to a previous TTT value to obtain or trigger an early measurement report based on the RRC reconfiguration. The process 800 may also involve processor 712 of communication apparatus 710 transmitting, via transceiver 716, the early measurement report to the serving cell.

In some implementations, process 800 may further involve processor 712 of communication apparatus 710 indicating a list or a flag in the RRC complete message. The flag may indicate whether the condition is met. The list may indicate any neighbor cell whose signal strength or signal quality is higher or greater than a threshold.

In some implementations, process 800 may involve processor 712 of communication apparatus 710 camping on a serving cell. The process 800 may also involve processor 712 of communication apparatus 710 performing a cell reselection procedure in an idle state or an inactive state. The process 800 may also involve processor 712 of communication apparatus 710 initiating the connection establishment procedure or the connection resume procedure.

In some implementations, process 800 may involve processor 712 of communication apparatus 710 determining whether the cell reselection procedure is ongoing after initiating the connection establishment procedure or the connection resume procedure. The process 800 may also involve processor 712 of communication apparatus 710 evaluating the condition in an event that the cell reselection procedure is not ongoing.

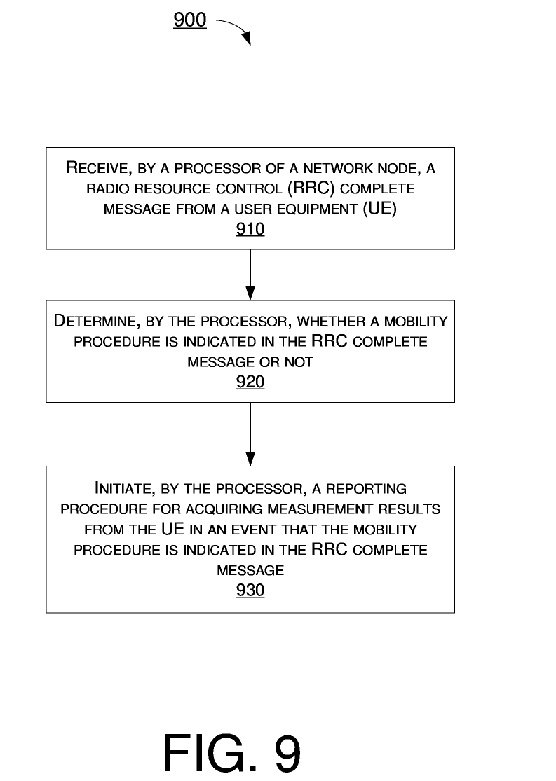

FIG. 9 illustrates an example process 900 in accordance with an implementation of the present disclosure. Process 900 may be an example implementation of above scenarios/schemes, whether partially or completely, with respect to early mobility and reporting procedures in the cell edge of the present disclosure. Process 900 may represent an aspect of implementation of features of network apparatus 720. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by network apparatus 720 or any suitable network device or machine type devices. Solely for illustrative purposes and without limitation, process 900 is described below in the context of network apparatus 720. Process 900 may begin at block 910.

At block 910, process 900 may involve processor 722 of network apparatus 720 receiving, via transceiver 726, an RRC complete message from a UE. Process 900 may proceed from block 910 to block 920.

At block 920, process 900 may involve processor 722 of network apparatus 720 determining whether a mobility procedure (e.g., an early mobility procedure) is indicated in the RRC complete message. Process 900 may proceed from block 920 to block 930.

At block 930, process 900 may involve processor 722 of network apparatus 720 initiating a reporting procedure (e.g., an early reporting procedure) for acquiring measurement results from the UE in an event that the mobility procedure (e.g., the early mobility procedure) is indicated in the RRC complete message.

In some implementations, the RRC complete message is an RRC connection setup complete message or an RRC connection resume complete message.

In some implementations, process 900 may involve processor 722 of network apparatus 720 transmitting, via transceiver 726, a UE information request to the UE during the reporting procedure (e.g., the early reporting procedure). The process 900 may involve processor 722 of network apparatus 720 receiving, via transceiver 726, a UE information response during the reporting procedure (e.g., the early reporting procedure). The UE information response may include the measurement results. The measurement results may include an idle mode measurement result or an inactive measurement result of network apparatus 720 and a neighbor cell.

In some implementations, process 900 may involve processor 722 of network apparatus 720 reconfiguring a measurement configuration in an event that a connection establishment procedure with communication apparatus 710 or a connection resume procedure with communication apparatus 710 is completed, and the mobility procedure (e.g., the early mobility procedure) is indicated in the RRC complete message. The process 900 may involve processor 722 of network apparatus 720 transmitting, via transceiver 726, the measurement configuration to the UE. The process 900 may involve processor 722 of network apparatus 720 receiving, via transceiver 726, a measurement report (e.g., an early measurement report) including the measurement results of network apparatus 720 and a neighbor cell according to the measurement configuration.

In some implementations, the measurement results of network apparatus 720 and the neighbor cell may be retrieved by performing a measurement with a zero time-to-trigger (TTT) value or a shorter TTT value compared to a previous TTT value.

In some implementations, the reporting procedure (e.g., the early reporting procedure) may be initiated in an event that a security protection procedure has been activated.

In some implementations, the reporting procedure (e.g., the early reporting procedure)may be initiated in an event that a security protection procedure has been activated, and the mobility procedure (e.g., the early mobility procedure) is indicated in the RRC complete message.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, a first measurement;
determining, by the processor, whether a condition is met based on the first measurement; and
triggering, by the processor, a mobility procedure during a connection establishment procedure or a connection resume procedure in an event that the condition is met.

2. The method of claim 1, wherein the condition comprises at least one of that signal strength or signal quality of a neighboring cell is higher than a first threshold and that signal strength or signal quality of a serving cell signal is lower than a second threshold.

3. The method of claim 1, wherein the condition comprises signal strength or signal quality of a neighboring cell is higher than a first threshold but has not yet meet a time interval, or the signal strength or the signal quality of the neighboring cell is higher than the first threshold and has met a time interval but no more than 1 second has elapsed since the apparatus camped on a serving cell.

4. The method of claim 1, the triggering of the mobility procedure further comprises:
indicating a need of the mobility procedure in a radio resource control (RRC) complete message during the connection establishment procedure or the connection resume procedure; and
transmitting, by the processor, the RRC complete message to a serving cell.

5. The method of claim 4, wherein the RRC complete message is an RRC connection setup complete message or an RRC connection resume complete message.

6. The method of claim 1, further comprising:
receiving, by the processor, a UE information request from a serving cell after triggering the mobility procedure; and
transmitting, by the processor, a UE information response to the serving cell, wherein the UE information response comprises a measurement result of the first measurement.

7. The method of claim 1, further comprising:
receiving, by the processor, an RRC reconfiguration from a serving cell after triggering the mobility procedure;
performing, by the processor, a second measurement with a zero time-to-trigger (TTT) value or a shorter TTT value compared to a previous TTT value to trigger a measurement report based on the RRC reconfiguration; and
transmitting, by the processor, the measurement report to the serving cell.

8. The method of claim 4, wherein the indicating of the need of the mobility procedure further comprises:
indicating a list or a flag in the RRC complete message, wherein the flag indicates whether the condition is met, and wherein the list indicates any neighbor cell whose signal strength or signal quality is higher than a threshold.

9. The method of claim 1, further comprising:
camping, by the processor, on a serving cell;
performing, by the processor, a cell reselection procedure in an idle state or an inactive state; and
initiating, by the processor, the connection establishment procedure or the connection resume procedure.

10. The method of claim 9, further comprising:
determining, by the processor, whether the cell reselection procedure is ongoing after initiating the connection establishment procedure or the connection resume procedure; and
evaluating, by the processor, the condition in an event that the cell reselection procedure is not ongoing.

11. An apparatus, comprising:
a transceiver, during operation, wirelessly communicates with a wireless network; and
a processor communicatively coupled to the transceiver such that, during operation, the processor performs operations comprising:
performing, via the transceiver, a first measurement;
determining whether a condition is met based on the first measurement; and
triggering a mobility procedure during a connection establishment procedure or a connection resume procedure in an event that the condition is met.

12. The apparatus of claim 11, wherein the processor is further configured to perform operations comprising:
indicating a need of the mobility procedure in a radio resource control (RRC) complete message; and
transmitting, via the transceiver, the RRC complete message to a serving cell.

13. The apparatus of claim 11, wherein the processor is further configured to perform operations comprising:
receiving, via the transceiver, a UE information request from a serving cell after triggering the mobility procedure; and
transmitting, via the transceiver, a UE information response to the serving cell, wherein the UE information response comprises a measurement result of the first measurement.

14. The apparatus of claim 11, wherein the processor is further configured to perform operations comprising:
receiving, via the transceiver, an RRC reconfiguration from a serving cell after triggering the mobility procedure;
performing, via the transceiver, a second measurement with a zero time-to-trigger (TTT) value or a shorter TTT value compared to a previous TTT value to trigger a measurement report based on the RRC reconfiguration; and
transmitting, via the transceiver, the measurement report to the serving cell.

15. A method, comprising:
receiving, by a processor of a network node, a radio resource control (RRC) complete message from a user equipment (UE);
determining, by the processor, whether a mobility procedure is indicated in the RRC complete message; and
initiating, by the processor, a reporting procedure for acquiring measurement results from the UE in an event that the mobility procedure is indicated in the RRC complete message.

16. The method of claim 15, wherein the RRC complete message is an RRC connection setup complete message or an RRC connection resume complete message.

17. The method of claim 15, further comprising:
transmitting, by the processor, a UE information request to the UE during the reporting procedure; and
receiving, by the processor, a UE information response during the reporting procedure, wherein the UE information response comprises the measurement results, and wherein the measurement results comprise an idle mode measurement result or an inactive mode measurement result of the network node and a neighbor cell.

18. The method of claim 15, wherein the performing of the reporting procedure further comprises:
reconfiguring, by the processor, a measurement configuration in an event that a connection establishment procedure or a connection resume procedure is completed and the mobility procedure is indicated in the RRC complete message;
transmitting, by the processor, the measurement configuration to the UE; and
receiving, by the processor, a measurement report comprising the measurement results of the network node and a neighbor cell according to the measurement configuration.

19. The method of claim 18, wherein the measurement results of the network node and the neighbor cell are retrieved by performing a measurement with a zero time-to-trigger (TTT) value or a shorter TTT value compared to a previous TTT value.

20. The method of claim 15, wherein the reporting procedure is initiated in an event that a security protection procedure has been activated.
